(19) United States
(12) Patent Application Publication
(10) Pub. No.: US 2010/0178054 A1
(43) Pub. Date: Jul. 15, 2010

(54) ETHERNET/OPTICAL SIGNAL CONVERTER USING POWER OVER ETHERNET

(75) Inventor: Jeffrey Cain, Los Gatos, CA (US)

Correspondence Address: BAINWOOD HUANG & ASSOCIATES LLC, 2 CONNECTOR ROAD, WESTBOROUGH, MA, 01581, US

(73) Assignee: CISCO TECHNOLOGY, INC., San Jose, CA (US)

(21) Appl. No.: 12/352,148

(22) Filed: Jan. 12, 2009

(51) Int. Cl. H04J 14/00; H04L 29/06

(52) U.S. Cl. 398/58; 370/466

(57) ABSTRACT

A disclosed converter includes a first interface component configured to receive a power signal via a frame-based computer networking connection. The converter includes a second interface component disposed in electrical communication with the first interface component. The second interface component is configured to receive the power signal from the first interface component, receive a data signal, and convert the data signal between a signal having a first physical layer compatibility and a signal having a second physical layer compatibility using the power signal.

### BACKGROUND

Computer and information networks allow computer systems to exchange content or data. For example, Local Area Networks (LANs) provide communication and allow content exchange between computerized devices in business, campus, and residential environments. The predominant protocol for LAN communications is Ethernet. The Ethernet physical and data link layer specifications (e.g., Layer 1 and Layer 2 respectively) define how computerized devices exchange content over various types of physical connections such as twisted wire pairs, coaxial cables, and fiber optic cables.

For example, computerized devices configured for use on a LAN typically include a media access controller (MAC) and a physical interface transceiver (PHY). Conventional MACs are defined by the IEEE-802.3 Ethernet standard and are configured in the computerized devices as data link layers. Conventional PHYs connect corresponding MACs to a physical medium, such as a Category 5 twisted-pair wire, and are configured to exchange data between the MAC and the physical medium. In a receive mode, the PHY receives data from the physical medium and decodes the data into a form appropriate for the receiving computerized device. In a transmit mode, the PHY takes data from the computerized device, typically from the MAC, and converts the data into a form appropriate for the physical medium in use.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 illustrates an example schematic representation of a system having a converter.

FIG. 2 is an example schematic representation of the converter of FIG. 1.

FIG. 3 illustrates an example method of operation of the converter of FIG. 1.

FIG. 4A 2 is an example schematic representation of the converter of FIG. 2.

FIG. 4B illustrates another example of the converter of FIG. 2.

### DETAILED DESCRIPTION

### Overview

Communications sent over twisted wire pairs are limited in the distances that they can effectively travel. In general, twisted pair communications are limited to distances of up to 100 meters. Communications transmitted via fiber optic interfaces are capable of traveling vastly greater distances (on the order of kilometers) than twisted pair communications. However, fiber optic interfaces are not as common as twisted pair interfaces, and thus many devices that send Ethernet signals do not have fiber optic interfaces. Additionally, many devices that send Ethernet signals, in particular older devices, are incapable of being upgraded to add a fiber optic interface. Since fiber optic interfaces are relatively expensive, even devices that can be upgraded to include a fiber optic interface may only be able to achieve fiber optic capability at considerable cost. Thus there are many devices that are either physically or cost prohibitively unable to achieve Ethernet communications over large distances.

Certain PHYs can be used to convert an Ethernet signal from a standard for Ethernet over twisted pair cable to a standard for Ethernet over fiber optic cable. For a PHY to convert a signal, it must have access to a power source such as a wall outlet. However, there are situations where there may not be access to a power source. Thus when a power source is unavailable, there can be no signal conversion. In situations where a power source is available, the PHY must be near the power source. Thus signal conversion by a PHY is limited to areas with local access to a power source.

Generally, a disclosed converter includes a first interface component configured to receive a power signal via a frame-based computer networking connection. The converter includes a second interface component disposed in electrical communication with the first interface component. The second interface component is configured to receive the power signal from the first interface component, receive a data signal, and convert the data signal between a signal having a first physical layer compatibility and a signal having a second physical layer compatibility using the power signal.

### Description of Example Embodiments

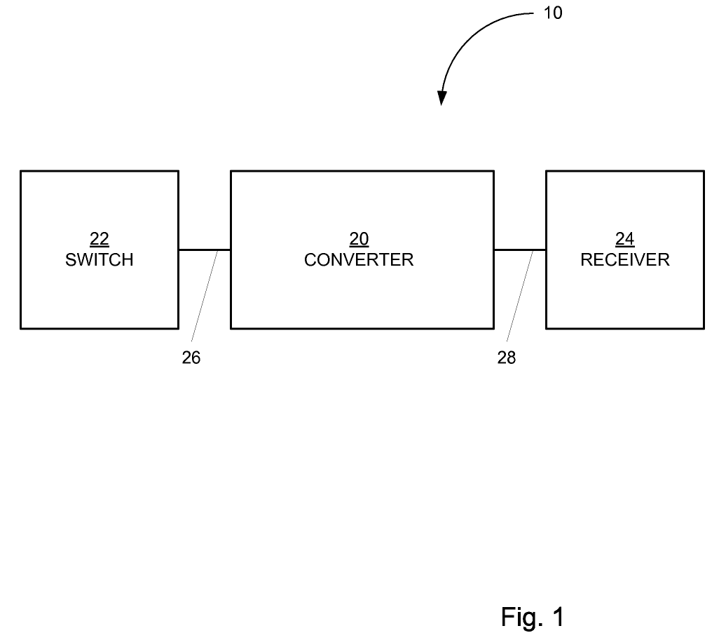

FIG. 1 illustrates a schematic representation of a data communications system 10 having a converter 20, a switch 22, and a receiver 24. The converter 20 is disposed in electrical communication with both the switch 22 and the receiver 24 and is configured to convert a signal between twisted-pair and optical standards. In one arrangement, the switch 22 is a network switch that processes and routes data at the Data link layer (layer 2) of the OSI model. An example switch 22 is a Cisco Catalyst 5000 series switch. The receiver 24 is configured as an Ethernet device, such as a personal computer, an Internet Protocol (IP) phone, or another network switch. In one arrangement, the switch 22 is disposed in electrical communication with the converter 20 via a copper physical medium 26, such as a Category 5 twisted-pair wire 26. The receiver 24 is disposed in electrical communication with the converter 22 via an optical physical medium 28, such as a fiber optic cable 28.

The converter 20 is configured to convert data signals from a twisted-pair standard to an optical standard. For example, in one arrangement, the switch 22 sends a data signal and a power signal along the copper physical medium 26 to the converter 20. The converter 20 uses the power signal to power the electrical components of the converter 20 to drive signal conversion. By using the power signal to power its electrical components, the converter 20 converts the data signal from a twisted-wire standard to an optical standard. Typical standards for Ethernet over twisted-pair cable include 10 BASE-T, 100 BASE-TX, and 1000 BASE-T. Typical standards for Ethernet over fiber optic cable include Serial Gigabit Media Independent Interface (SGMII). After the converter 20 converts the data signal to the optical standard, the converter 20 forwards the data signal along the optical physical medium 28 to the receiver 24.

In another arrangement, the converter 20 can covert data signals from the optical standard to the twisted-pair standard. For example, the switch 22 sends the power signal along the copper physical medium 26 and the receiver 24 sends the data signal in an optical standard along the optical physical medium 28. The converter 20 uses the power signal to power the electrical components of the converter 20 to drive signal conversion. By using the power signal to power its electrical components, the converter 20 converts the data signal from the optical standard to the twisted-pair standard. After the converter 20 converts the data signal to the twisted-pair standard, the converter 20 forwards the data signal along the copper physical medium 26 to the switch 22.

Since Ethernet signals can only travel over short distances via the copper physical medium 26 (e.g., less than 100 meters), a benefit of converting Ethernet signals to the optical standard for transmission over the optical physical medium 28 is that the switch 22 and the receiver 24 can be separated by relatively large distances (i.e., greater than 100 meters). Additionally, since not all devices can interface with the optical physical medium 28, a benefit of converting Ethernet signals from an optical to a twisted-pair standard for transmission over the copper physical medium 26 is that long distance communication can be achieved for switches 22 incapable of interfacing with the optical physical medium 28.

Furthermore, as seen in the above described arrangements, since the power signal is provided to the converter 20 over the copper physical medium 26, signal conversion can take place anywhere between the switch 22 and the receiver 24 regardless of the converter's 20 proximity to a power source such as a wall outlet. Thus signal conversion is not limited to locations with local access to a power source.

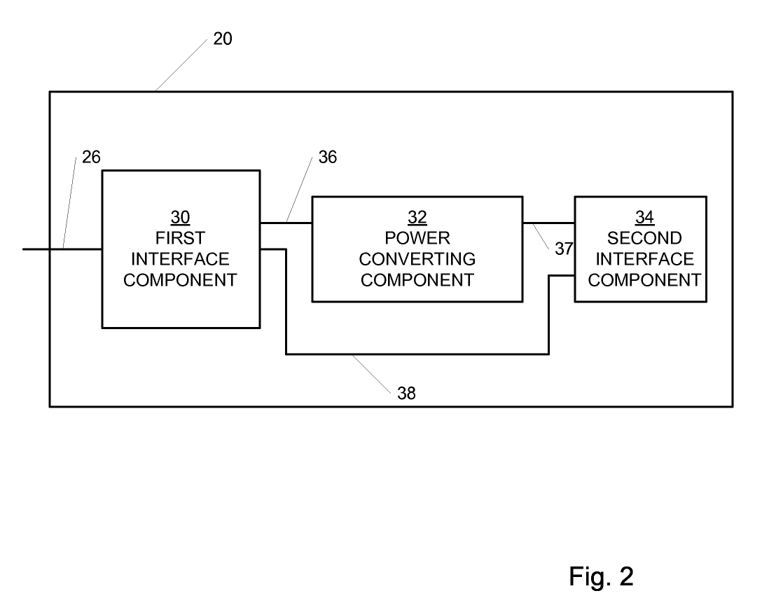

FIG. 2 is a schematic representation of an example of the converter 20. The converter 20 includes a first interface component 30, a power converting component 32, and a second interface component 34. The first interface component 30, the power converting component 32, and the second interface component 34 are all disposed in electrical communication with each other. For example, a first power transmission medium 36 and a data transmission medium 38 exit the first interface component 30. The first power transmission medium 36 provides an electrical communication link between the first interface component 30 and the power converting component 32. The data transmission medium 38 provides an electrical communication link between the first interface component 30 and the second interface component 34. Additionally a second power transmission medium 37 provides an electrical communication link between the power converting component 32 and the second interface component 34. In one arrangement, the first interface component 30, the power converting component 32, and the second interface component 34 are disposed within a housing. This arrangement results in a portable device.

The first interface component 30, such as a female RJ45 connector, is configured to receive power over Ethernet (POE) and data signals from an external device such as switch 22 (e.g., network switch). For example, while the first interface component 30 can have a variety of configurations, in one arrangement, the first interface component 30 is configured as a twisted-wire interface such as a male or female RJ45 connector. In use, the switch 22 delivers Ethernet over twisted pair to the first interface component 30. Some of the wires of the twisted pair are configured to transmit power while other wires of the twisted pair are configured to transmit data. The first interface component 30 provides the power it has received to the power converting component 32 via the first power transmission medium 36. The first interface component 30 also provides the data it has received to the second interface component 34 via the data transition medium 38.

The power converting component 32 is configured to convert power from a first level to a second level. POE delivers direct current to the power converting component 32 at approximately 48 volts (practically this amount can vary from about 45 volts to about 52 volts). This voltage is too powerful for a typical PHY acting as the second interface component 34 to convert the data signal. In order to use POE as an effective power source for data conversion in the converter 20, the voltage is reduced to approximately 3.3 volts. The power converting component 32 utilizes a circuit design that places elements such as inductors and resistors in a geometry that will reduce the voltage of the power signal from approximately 48 volts to approximately 3.3 volts. Various circuit design geometries are possible to achieve this voltage reduction.

The second interface component 34, in one arrangement, is configured to receive power from the power converting component 32 and covert the data signals between the twisted wire format (e.g., 1000 BASE-T) and the optical format (e.g., SGMII). While the second interface component 34 can be configured in a variety of ways, the second interface component 34 is configured as a physical interface transceiver (PHY), such as an Alaska 88E1112 Gigabit Ethernet transceiver manufactured by Marvell. In one arrangement, the second interface component 34 includes a media access controller (MAC) interface and a copper interface. The MAC interface includes input and output pins that respectively connect to a fiber optic transceiver's receive data and transmit data. The copper interface includes medium dependent interface (MDI) pins that connect to physical media for 10 BASE-T, 100 BASE-TX, and 1000 BASE-T. Between the copper interface and the MAC interface, the second interface component 34 contains circuitry configured to convert data signals between twisted-wire formats and optical formats. Various circuit design geometries are possible to achieve this data conversion.

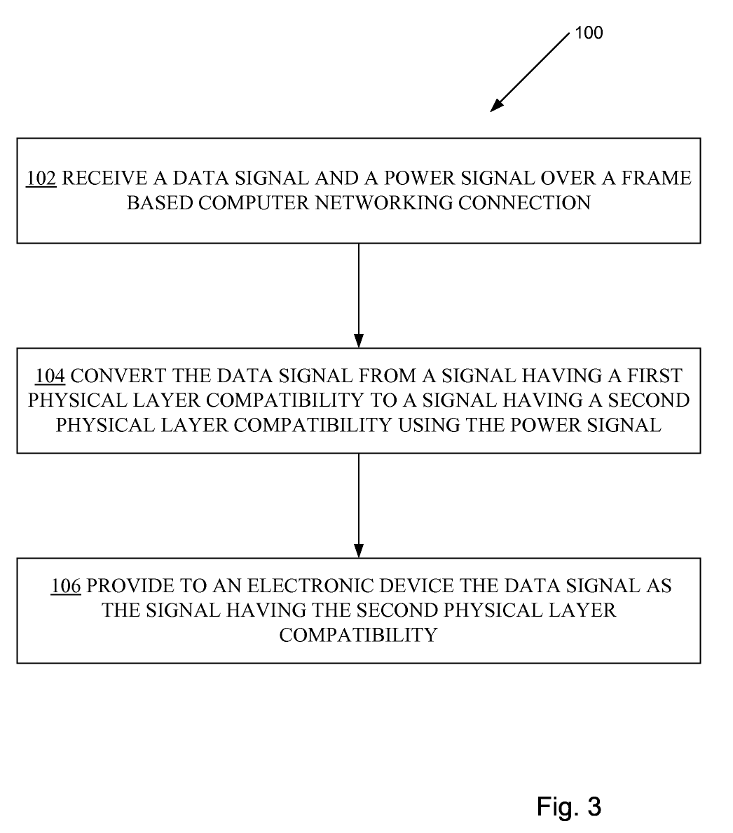

FIG. 3 is a flow diagram 100 depicting a method of operation of the converter 20. In step 102, the converter 20 receives the data signal and a power signal over a frame-based computer networking connection. For example, in an arrangement where data is converted from a twisted pair standard to an optical standard, the first interface component 30 receives the power and data signal from an external device, such as the switch 22, and delivers the power signal via the first power transmission medium 36 to the power converting component 32. Additionally, the first interface component 30 delivers received the data signal via the data transmission medium 38 to the second interface component 34.

In step 104, the converter 20 converts the data signal from a signal having a first physical layer compatibility to a signal having a second physical layer compatibility using the power signal. For example, with reference to FIG. 2, the power converting component 32 adjusts the voltage of the power signal so that the power signal is usable by the second interface component 34. After adjusting the voltage of the power signal, the power converting component 32 sends the adjusted power signal to the second interface component 34 via the second power transmission medium 37. Since the data signal in this arrangement is transmitted to the second interface component 34 via the data transmission medium 38, the circuitry of the second interface component 34, powered by the adjusted power signal, converts the data signal from the twisted-pair standard to the optical standard.

In step 106, the converter 20 provides to an electronic device the data signal as the signal having the second physical layer compatibility. For example, because the data signal in this arrangement has been converted to the optical standard, the data signal is forwarded to the receiver 24 via the fiber optic cable 28.

While the converter 20 has been described as converting from the twisted pair standard to an optical standard, the converter 20 can also convert from the optical standard to the twisted pair standard. For example, when data is converted from an optical standard to a twisted pair standard, the first interface component 30 delivers the power signal via the first power transmission medium 36 to the power converting component 32. Additionally, the data signal is delivered via the fiber optic cable 28 to the second interface component 34. The power converting component 32 adjusts the voltage of the power signal so that the power signal is usable by the second interface component 34. After adjusting the voltage of the power signal, the power converting component 32 sends the adjusted power signal to the second interface component 34 via the second power transmission medium 37. Since the data signal in this arrangement is transmitted to the second interface component 34 via the fiber optic cable 28, the circuitry of the second interface component 34, powered by the adjusted power signal converts the data signal from the optical standard to the twisted-pair standard. Since the data signal in this arrangement is converted to the twisted-pair standard, then the data signal is delivered from the second interface component 34 via the data transmission medium 38 to the first interface component 30 and is then forwarded to the switch 22.

With respect to the above described converter 20, based upon its configuration, because the converter receives power over Ethernet, the converter 20 is not restricted to operation near a power source, such as a wall outlet. Accordingly, an end user can transport and position the converter 20 at any location relative to a switch 22. Additionally, because the converter 20 receives signals from a single port of a switch 22, an end user can upgrade a switch 22 with fiber optic capability on a per-port basis.

The converter 20 configured to perform the above described method may come in a variety of forms. As will be discussed in further detail below, certain converters contain built in optical elements while others are configured to attach to external optical elements.

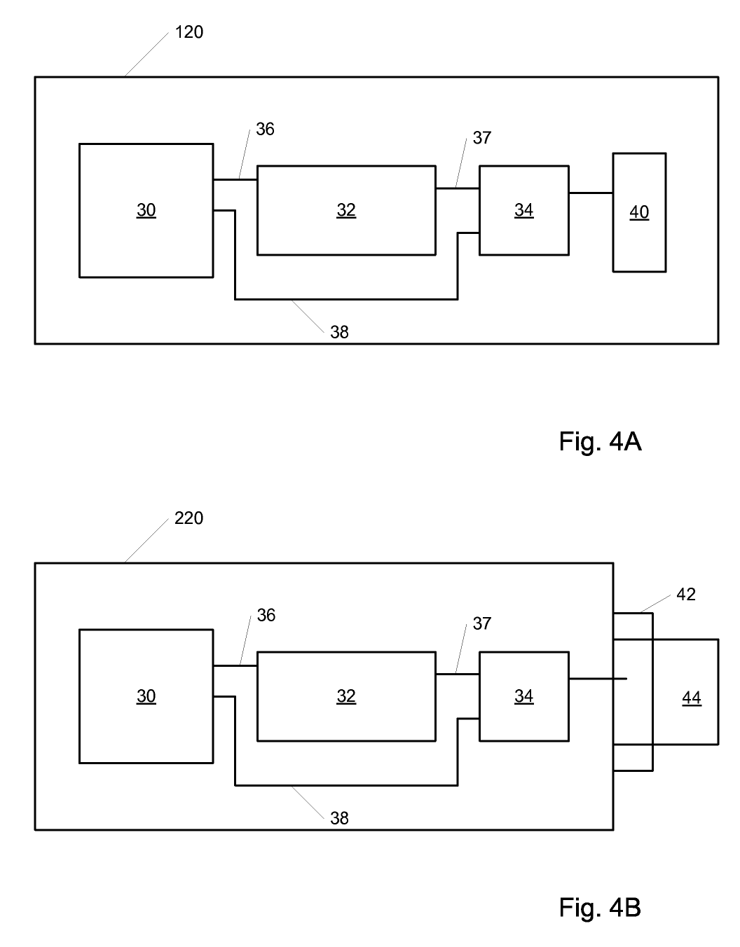

FIG. 4A depicts a converter 120 that includes the first interface component 30, the power converting component 32, the second interface component 34, and an optical element 40. The first interface component 30, the power converting component 32, and the second interface component 34 are all disposed in electrical communication with each other and the second interface component 34 is disposed in electrical communication with the optical element 40. The optical element 40 is configured as a fiber optic transceiver, such as a small form-factor pluggable (SFP) having a set of lasers and a set of optical sensors. The optical element 40 is configured to receive a data signal in the optical standard and transmit a fiber optic signal across a fiber optic cable. For example, the SFP receives the data signal as an electrical signal in the optical standard and converts it to the data signal as an optical signal in the optical standard by shining its lasers into the fiber optic cable. Alternatively the optical element 40 is also configured to receive the fiber optic signal from the fiber optic cable and transmit the data signal in the optical standard to the second interface component. For example, the SFP receives the data signal as an optical signal in the optical standard on the set of optical sensors and converts it to the data signal as an electrical signal in the optical standard and sends it to the second interface component 34.

Because the converter 120 is configured as a single unit, the end user can utilize data converting capabilities of the converter 120 without the additional expense related to purchasing a separate SFP. In this arrangement, the first interface component 30, the power converting component 32, the second interface component 34, and the optical element 40 are formed as one unit, such as on a single circuit board contained in a single housing to form a portable device. The portable device may be in the form of a small (e.g., less than a cubic inch) dongle that is hot pluggable with the switch 22.

Other forms of the converter 20 may not include an integral optical element and instead be configured to connect to an external optical element. For example, FIG. 4B depicts a converter 220 that includes the first interface component 30, the power converting component 32, the second interface component 34, and an optical element cage 42. The first interface component 30, the power converting component 32, and the second interface component 34 are all in electrical communication with each other and contained in a single housing. The housing may include or actually be the optical element cage 42.

An external optical element 44 is configured to mechanically attach to the optical element cage 42 and be in electrical communication with the second interface component when mechanically attached to the optical element cage 42. The optical element cage 42 may also be configured to provide EMI shielding to the components it surrounds. In one arrangement, the external optical element 44 is fiber optic transceiver such as a small form-factor pluggable. The optical element cage 42 allows the mechanical attachment of the fiber optic cable 28 to the converter 220.

While various embodiments of the invention have been particularly shown and described, it will be understood by those skilled in the art that various changes in form and details may be made therein without departing from the spirit and scope of the invention as defined by the appended claims.

For example, FIG. 1 depicts a single converter 20 being used to convert the data signal. However, multiple converters may be used in succession with each other. For example, a first network switch may send a data signal over a first twisted pair cable. A first converter 20 may be used to convert the data signal to the optical standard to travel over a fiber optic cable. A second converter may them be used to convert the data signal from the optical format back to the twisted-pair standard and to travel over a second twisted pair cable to a second network switch.

Additionally, the power converting component 32, as described, is used when the second interface component 34 is a typical PHY that operates on 3.3 volts of power. However, there may be other PHYs that can convert signals at other voltages. For a PHY that operates at voltages other than 3.3 volts, the power converting component 32 is arranged to convert the power signal to those other voltages. If the PHY can operate at the voltage which POE delivers direct current, the power converting component 32 is not necessary and may be omitted.

What is claimed is:

1. A converter, comprising:
a first interface component configured to receive a power signal via a frame-based computer networking connection; and
a second interface component disposed in electrical communication with the first interface component and configured to receive the power signal from the first interface component, receive a data signal, and convert the data signal between a signal having a first physical layer compatibility and a signal having a second physical layer compatibility using the power signal.

2. The converter of claim 1, further comprising a power converting component configured to receive the power signal from the first interface component at a first voltage, convert the power signal from the first voltage to a second voltage, and forward the power signal to the second interface component at the second voltage.

3. The converter of claim 1, wherein the first interface component, the power converting component, and the second interface component are disposed within a housing to form a portable device.

4. The converter of claim 1, wherein the signal having the first physical layer compatibility is a standard for Ethernet over twisted-pair cable and the signal having the second physical layer compatibility is a standard for Ethernet over fiber optic cable.

5. The converter of claim 4, wherein:
the standard for Ethernet over twisted-pair cable is selected from the group consisting of 10 BASE-T, 100 BASE-TX, and 1000 BASE-T; and
the standard for Ethernet over fiber optic cable is Serial Gigabit Media Independent Interface (SGMII).

6. The converter of claim 4, wherein the converter further comprises an optical element that is configured to (i) receive the data signal from the second interface component in the standard for Ethernet over fiber optic cable, and (ii) forward the data signal in the standard for Ethernet over fiber optic cable over a fiber optic cable.

7. The converter of claim 1, wherein the converter further comprises an optical element cage connected to the second interface component that is configured to attach to an external optical element that is configured to (i) receive the data signal from the second interface component in the standard for Ethernet over fiber optic cable, and (ii) forward the data signal in the standard for Ethernet over fiber optic cable over a fiber optic cable.

8. The converter of claim 2, wherein:
the first voltage comprises a voltage in the range between about 45 volts and 52 volts; and
the second voltage comprises a voltage in the range between about 3 volts and 4 volts.

9. A method, comprising:
receiving a data signal and a power signal over a frame based computer networking connection at a converter;
converting the data signal by the converter from a signal having a first physical layer compatibility to a signal having a second physical layer compatibility using the power signal; and
providing to an electronic device by the converter the data signal as the signal having the second physical layer compatibility.

10. The method of claim 9 further comprising prior to converting the data signal, converting the power signal from a first voltage to a second voltage, wherein the first voltage is greater than the first voltage.

11. The method of claim 9, wherein converting the data signal by the converter from the signal having the first physical layer compatibility to the signal having the second physical layer compatibility using the power signal comprises converting the data signal by the converter from a standard for Ethernet over twisted-pair cable to a standard for Ethernet over fiber optic cable.

12. The method of claim 11, wherein converting the data signal by the converter from the standard for Ethernet over twisted-pair cable to the standard for Ethernet over fiber optic cable comprises converting the data signal by the converter from a standard selected from the group consisting of 10 BASE-T, 100 BASE-TX, and 1000 BASE-T to a Serial Gigabit Media Independent Interface (SGMII) standard.

13. The method of claim 9, wherein converting the data signal by the converter from the signal having the first physical layer compatibility to the signal having the second physical layer compatibility using the power signal comprises converting the data signal by the converter from a standard for Ethernet over fiber optic cable to a standard for Ethernet over twisted-pair cable.

14. The method of claim 13, wherein converting the data signal by the converter from the standard for Ethernet over fiber optic cable to the standard for Ethernet over twisted-pair cable comprises converting the data signal by the converter from a Serial Gigabit Media Independent Interface (SGMII) standard to a standard selected from the group consisting of 10 BASE-T, 100 BASE-TX, and 1000 BASE-T.

15. A data conversion system, comprising:
a switch configured to send a data signal and a power signal over Ethernet;
a converter disposed in electrical communication with the switch, the converter including:
a first interface component configured to receive a power signal via a frame-based computer networking connection, and
a second interface component disposed in electrical communication with the first interface component and configured to receive the power signal from the first interface component, receive a data signal, and convert the data signal between a signal having a first physical layer compatibility and a signal having a second physical layer compatibility using the power signal; and
a receiver disposed in electrical communication with the converter and configured to receive the data signal as the signal having the second physical layer compatibility.

16. The data conversion system of claim 15, wherein the converter further comprises a power converting component configured to receive the power signal from the first interface component at a first voltage, convert the power signal from the first voltage to a second voltage, and forward the power signal to the second interface component at the second voltage.

17. The data conversion system of claim 16, wherein the first interface component, the power converting component, and the second interface component are disposed within a housing to form a portable device.

18. The converter of claim 15, wherein the signal having the first physical layer compatibility is a standard for Ethernet over twisted pair cable and the signal having the second physical layer compatibility is a standard for Ethernet over fiber optic cable.

19. The converter of claim 18, wherein:
the standard for Ethernet over twisted-pair cable is selected from the group consisting of 10 BASE-T, 100 BASE-TX, and 1000 BASE-T; and
the standard for Ethernet over fiber optic cable is Serial Gigabit Media Independent Interface (SGMII).

20. The data conversion system of claim 18, wherein the converter further comprises an optical element that is configured to (i) receive the data signal from the second interface component in the standard for Ethernet over fiber optic cable, and (ii) forward the data signal in the standard for Ethernet over fiber optic cable over a fiber optic cable.

21. The data conversion system of claim 15, wherein the converter further comprises an optical element cage connected to the second interface component that is configured to attach to an external optical element that is configured to (i) receive the data signal from the second interface component in the standard for Ethernet over fiber optic cable, and (ii) forward the data signal in the standard for Ethernet over fiber optic cable over a fiber optic cable.

22. The data conversion system of claim 15, wherein:
the first voltage comprises a voltage in the range between about 45 volts and 52 volts; and
the second voltage comprises a voltage in the range between about 3 volts and 4 volts.
